(19) United States
(12) Patent Application Publication
(10) Pub. No.: US 2010/0048112 A1
(43) Pub. Date: Feb. 25, 2010

(54) DIAMOND TOOL AND METHOD OF MANUFACTURING THE SAME

(75) Inventors: Hyun Woo Lee, Incheon (KR); Jong Hwan Park, Seoul (KR); Shin Kyung Kim, Incheon (KR); Dae Geun Kim, Seoul (KR)

Correspondence Address: SEED INTELLECTUAL PROPERTY LAW GROUP PLLC, 701 FIFTH AVE, SUITE 5400, SEATTLE, WA, 98104, US

(73) Assignee: SHINHAN DIAMOND IND. CO., LTD., Incheon (KR)

(21) Appl. No.: 12/524,552

(22) PCT Filed: Apr. 23, 2007
(86) PCT No.: PCT/KR2007/001978

§ 371 Date: Oct. 20, 2009

(30) Foreign Application Priority Data
Jan. 26, 2007 (KR) 10-2007-0008304

(51) Int. Cl. B23P 5/00; B24D 7/06; B24D 3/04

(52) U.S. Cl. 451/548; 51/307; 51/309; 51/298; 51/295

(57) ABSTRACT

Disclosed herein is a diamond tool for cutting a workpiece and a method of manufacturing the same. The diamond tool includes a shank and a segment coupled to the shank. The segment includes a tape having a plurality of inserting sections formed on a surface of the tape, and diamond particles inserted into the inserting sections and bonded to the tape by pressure sintering. The inserting sections are formed in the tape corresponding to desired arrangement locations of the diamond particles. The diamond particles can be arranged in various patterns in the segment, thereby achieving simplification of the process, which allows process automation and reduces manufacturing costs.

### BACKGROUND

1. Technical Field

The present invention relates to a diamond tool for cutting a workpiece and a method of manufacturing the same, and more particularly to a diamond tool that is manufactured using a tape having inserting sections formed thereon corresponding to arrangement locations of diamond particles such that the diamond particles can be arranged in a desired pattern, and a method of manufacturing the same.

2. Description of the Related Art

Diamond tools are tools for grinding or cutting the surface of a workpiece. The diamond tool generally has a shank that is in the form of a wheel or disk and is coupled to a machining apparatus, and segments attached to an outer periphery of the shank to cut a workpiece.

Each of the segments includes a binder in the form of paste and diamond particles irregularly dispersed in the binder. In manufacture of the segment, a mixture of the binder and the diamond particles is placed in a mold having a predetermined shape, sintered under heat and pressure, and dried to provide the segment.

Although such a conventional manufacturing method has a merit in that the segments can be easily manufactured, it is disadvantageous in that it suffers from deviation in quality of products due to irregular distribution of the diamond particles.

Therefore, to solve such problems, one example of techniques for arranging diamond particles in a predetermined regular pattern is disclosed in U.S. Pat. No. 2,194,546. If the diamond particles are arranged in the predetermined regular pattern, it is possible to obtain regular arrangement of the diamond particles, which leads to enhancement in performance of products and to deviation reduction of the performance, improving reliability of the products.

As mentioned above, various methods for arranging the diamond particles in the predetermined regular pattern have been actively developed since the early 1990s, and examples thereof are disclosed in U.S. Pat. Nos. 4,925,457, 5,092,910, 5,049,165. In these methods, a wire mesh or a mesh screen having diamond particles arranged regularly thereon is placed on a flexible carrier formed of a thermoplastic binder and metallic fibers or a mixture thereof, and the diamond particles are then fitted into openings of the wire mesh or the mesh screen.

On the other hand, Korean Patent No. 366466 discloses a diamond tool and a method of manufacturing the same, which comprises preparing a metal matrix in a semi-dried state, placing a perforated plate (or wire mesh) having holes formed therein on the metal matrix, inserting diamond particles into the respective holes, and compressing the diamond particles to fit the diamond particles into the matrix or bonding the diamond particles to the matrix with an organic material so as to form a segment.

FIG. 1 is a flow diagram showing manufacture of a segment by a conventional method of manufacturing a diamond tool.

A conventional diamond tool comprises a shank and a segment 10 coupled to the shank to perform an actual cutting operation. To manufacture the segment 10, a sliced matrix 12 is prepared and a perforated plate (wire mesh) 14 having holes 15 formed therein is placed on the matrix 12. At this time, the holes 15 formed in the perforated plate 14 have a size necessary to allow diamond particles to pass therethrough and can be arranged generally at constant intervals. Therefore, the diamond particles 16 can be arranged at such intervals by fitting the diamond particles 16 into the holes 15.

Meanwhile, the matrix 12 is prepared in a semi-dried state, and thus, with the diamond particles 16 fitted into the holes 15, the upper sides of the diamond particles 16 are lightly pushed down by a compression platen 20 such that the diamond particles 16 can be fixed in place in the matrix 12 while being buried in the matrix.

Then, after lifting the compression platen 20 to remove the perforated plate 14, the diamond particles 16 are completely buried in the matrix 12 by sufficiently lowering the compression platen 20.

In the segment 10 produced by the procedure as described above, the diamond particles 16 can be arranged in multiple layers by repeating a series of such processes.

In such a conventional diamond tool and method of manufacturing the same, however, since the perforated plate (or wire mesh) 14 must be aligned with the matrix 12 to arrange the diamond particles 16 and the process of compressing the arranged diamond particles 16 on the matrix 12 is constituted of two steps, the process becomes complicated and the manufacturing time thereof increases. Furthermore, when arranging the diamond particles 16 using the wire mesh, although the diamond particles 16 can be arranged generally at constant intervals, they cannot be arranged in a desired pattern.

On the other hand, in the related art, there has been suggested a method of arranging the diamond particles on a powder compact or a metallic thin plate using an air suction jig. In this case, however, since the diamond particles are not secured to the surface of the powder compact or the metallic thin plate, the diamond particles are likely to move, making it difficult to obtain a desired arrangement of the diamond particles. Therefore, in the related art, a bonding material such as adhesives and the like is additionally applied to the surface of the powder compact or the metallic thin plate and such an additional process results in productivity reduction. Furthermore, when sintering the compact to bond the diamond particles to the powder compact or the metallic thin plate, the adhesives applied to the surface of the powder compact or the metallic thin plate remain as impurities, causing deterioration of the diamond tool, and such adhesives and the like applied to secure the diamond particles make it difficult to achieve process automation.

### BRIEF SUMMARY

According to one embodiment, a diamond tool is manufactured using a tape having inserting sections formed therein corresponding to arrangement locations of diamond particles such that the diamond particles can be arranged in a desired pattern. According to one embodiment, a method of manufacturing the diamond tool is provided.

In accordance with one aspect, a diamond tool includes a shank and a segment coupled to the shank, the segment including a tape having a plurality of inserting sections formed on a surface of the tape, and diamond particles inserted into the inserting sections and bonded to the tape, for example, by pressure sintering, the plurality of inserting sections being formed on the surface of the tape corresponding to desired arrangement locations of the diamond particles.

In accordance with one aspect, the tape is a thick film having a plurality of through-holes formed on a surface of the thick film to form the inserting sections. In accordance with one aspect, the tape may include a secondary thick film disposed on a lower surface of the thick film to block the through-holes. In accordance with one aspect, the tape may include a thick film having a plurality of grooves formed on a surface of the thick film to form the insertion sections. In accordance with one aspect, the segment may include a secondary thick film stacked on an upper surface of the tape having the diamond particles inserted into the tape. In accordance with one aspect, the segment may include a plurality of the tapes stacked in multiple layers, each of the tapes having the diamond particles inserted therein.

According to one embodiment, the inserting sections include a size of 110˜150% of a size of the diamond particles. In accordance with one aspect, the tape may include a material selected from the group consisting of a metal powder, a polymer compound, a ceramic material, and a mixture thereof.

According to one embodiment, a method of manufacturing a diamond tool includes preparing a tape having a plurality of inserting sections formed therein corresponding to desired arrangement locations of diamond particles, inserting the diamond particles into the inserting sections of the tape, and pressure sintering the diamond particles and the tape to bond the diamond particles to the tape to form a segment.

In accordance with one aspect, preparing the tape may include preparing a mixture of a raw powder and a binder, and preparing a thick film having a plurality of through-holes formed therein by applying the mixture to the tape to form the inserting sections corresponding to desired arrangement locations of the diamond particles. In accordance with one aspect, preparing the thick film, the through-holes may be formed in the thick film after drying the thick film formed by application of the mixture. In accordance with one aspect, preparing the tape may include applying the mixture to a lower surface of the thick film to form a secondary thick film to block the through-holes. In accordance with one aspect, preparing the tape may include preparing a mixture of a raw powder and a binder, and preparing a thick film having a plurality of grooves formed therein by applying the mixture to the tape to form the inserting sections corresponding to the arrangement locations of the diamond particles. In accordance with one aspect, inserting the diamond particles may include supplying the diamond particles onto the surface of the tape, and removing remaining diamond particles that are not inserted into the inserting sections. In accordance with one aspect, removing the remaining diamond particles may include tilting the tape or applying vibration to the tape to remove the remaining diamond particles that are not inserted into the inserting sections. In accordance with one aspect, the method may include stacking a secondary thick film on an upper surface of the tape having the diamond particles inserted therein before pressure sintering the diamond particles and the tape. In accordance with one aspect, the method may include forming multiple layers by stacking additional tapes having the diamond particles inserted therein before pressure sintering the tape and the diamond particles, the forming of the multiple layers including preparing a plurality of the tapes, each having the plurality of inserting sections formed therein corresponding to desired arrangement locations of the diamond particles, inserting the diamond particles into the inserting sections of each of the tapes, and stacking the tapes one after another from below. The method may include degreasing the binder before pressure sintering the diamond particles and the tape. In accordance with one aspect, the raw powder may comprise a material selected from the group consisting of a metal powder, a polymer compound, a ceramic material, and a mixture thereof. In accordance with one aspect, the inserting sections have a size of 110˜150% of the diamond particles. The method may include forming a spherical coating layer on the surface of each of the diamond particles before inserting the diamond particles.

### BRIEF DESCRIPTION OF THE SEVERAL VIEWS OF THE DRAWINGS

FIG. 1 is a flow diagram showing manufacture of a segment according to a prior art method of manufacturing a diamond tool;

FIG. 2 is a plan view of a diamond tool according to one embodiment;

FIG. 3 is a cross-sectional view of a segment of a diamond tool according to one embodiment;

FIG. 4 is a cross-sectional view illustrating a segment of a diamond tool according to another embodiment;

FIG. 5 is a view illustrating a tape casting apparatus for producing a tape for a diamond tool according to one embodiment;

FIGS. 6 (a) and (b) are isometric views illustrating a tape for a diamond tool according to one embodiment;

FIG. 7 is a flow diagram illustrating a segment at different steps of a method of manufacturing a diamond tool according to one embodiment of the;

FIG. 8 is a flow chart showing manufacturing steps of a segment by a method of manufacturing a diamond tool according to one embodiment;

FIG. 9 is a cross-sectional view illustrating a coated state of a diamond particle of a diamond tool according to one embodiment; and

FIG. 10 is a cross-sectional view illustrating a segment manufactured by a method of manufacturing a diamond tool according to another embodiment.

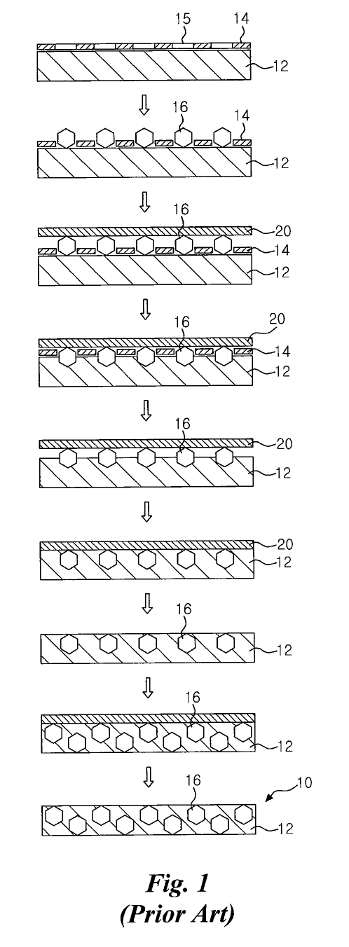

### DETAILED DESCRIPTION

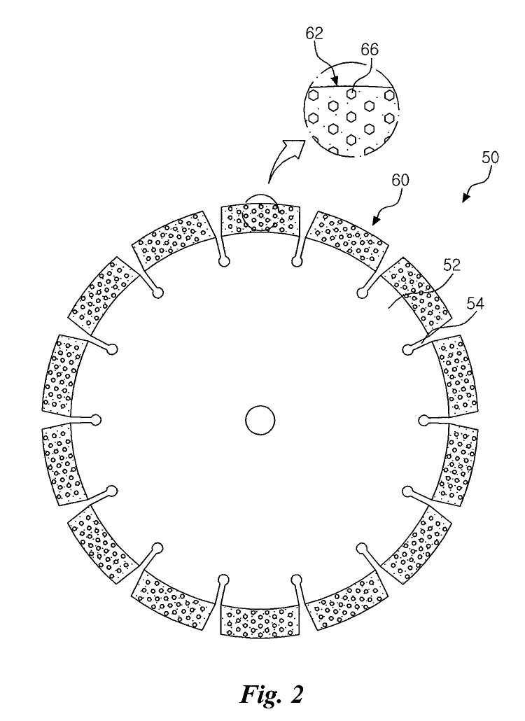

Example embodiments are described in detail with reference to the accompanying drawings in FIGS. 2-10 hereinafter.

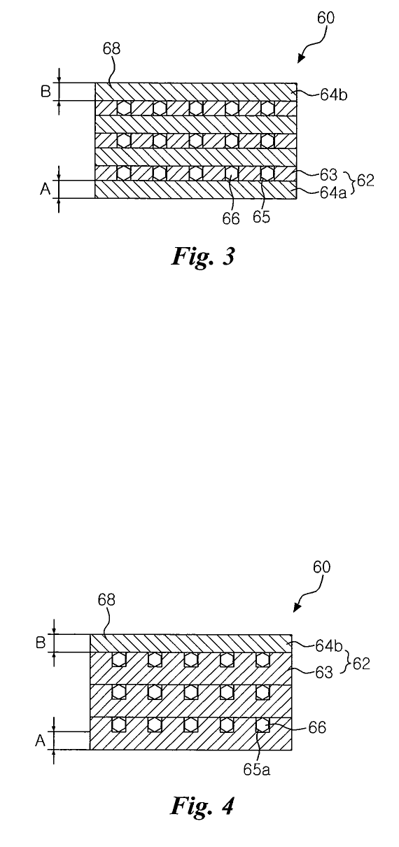

FIG. 2 is a plan view of a diamond tool according to one embodiment, and FIG. 3 is a cross-sectional view of a segment of a diamond tool according to one embodiment.

Referring to FIGS. 2 and 3, the diamond tool 50 includes a shank 52 that has a wheel or disk shape and is configured to be coupled to a machining apparatus. The shank 52 has slots 54 of a predetermined length formed along an outer periphery toward a central axis of the shank 52. Further, the diamond tool 50 includes a plurality of segments 60, each of which has a plurality of diamond particles 66 arranged therein, the segments being attached between the adjacent slots 54.

Each segment 60 includes tapes 62 formed by a tape casting process. In accordance with one aspect, each of the tapes 62 may be composed of a thick film 63 having a plurality of through-holes formed on the surface of the thick film 63 to constitute inserting sections 65. The diamond particles 66 are located in the respective inserting sections 65 and bonded integrally to the tape 62 by sintering.

According to one embodiment, each of the tapes 62 may include a lower-secondary thick film 64a disposed on a lower surface thereof. The lower-secondary thick film 64a serves to block one side of the through-holes such that the though holes are opened at the other side.

In accordance with one aspect, the tapes 62 and the diamond particles 66 inserted into the tapes 62 may be stacked in multiple layers. The segment 60 can further include an upper-secondary thick film 64b on upper surfaces of the uppermost tape 62 and the diamond particles 66 thereof. The thickness B of the upper-secondary thick film 64b stacked on the thick film 63 is, in accordance with one aspect, the same as the thickness A of the lower-secondary thick film 64a on the lower surface of the thick film 63. Alternatively, the upper- and lower-secondary thick films 64a, 64b have a variety of thicknesses for improvement of the segment performance.

Therefore, in each of the segments 60, a separation between adjacent layers of the diamond particles 66 can be adjusted depending on the thickness of the tape 62, that is, the thickness of the thick film 63 or the secondary thick films 64a, 64b.

In accordance with one aspect, the inserting sections 65 have a size which enables the respective diamond particles 66 to be inserted therein, and in accordance with one aspect, have a size of 110˜150% of the diamond particles 66.

In accordance with one aspect, the inserting sections 65 are formed to the size of 110˜150% of the diamond particles 66, facilitating easy insertion of the diamond particles 66 into the respective inserting sections 65 while preventing two or more diamond particles from entering a single inserting section 65.

Although the segment has been described as being formed using the tapes, each of which is formed with the inserting sections 65 and includes the thick film 63 having the through-holes and the secondary thick films 64a and 64b on the thick film 63 in the above embodiment, it is possible to form grooves 65a directly on the surface of the tape corresponding to desired arrangement locations of the diamond particles 66, such as that shown in FIG. 4.

A process of producing a tape for the diamond tool according to one embodiment is described as follows.

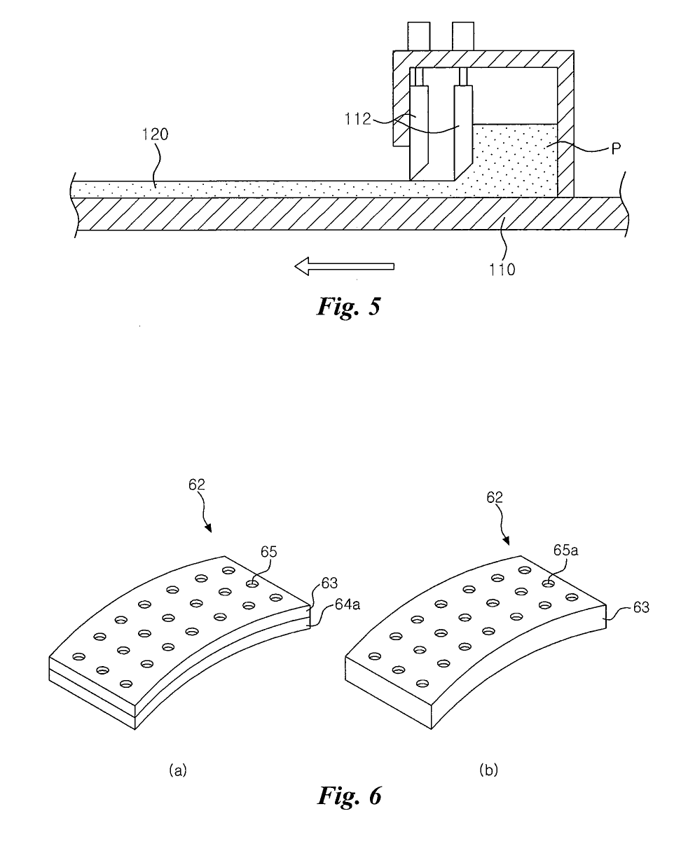

FIG. 5 illustrates a tape casting apparatus for producing a tape for the diamond tool according to one embodiment, and FIGS. 6 (a) and (b) are perspective views illustrating a tape for the diamond tool according to one embodiment. A tape casting process used for producing the tape 62, according to one embodiment, is described with reference to FIGS. 5 and 6 hereinafter.

In the tape casting process, a mixture P of a raw powder and organic compounds is cast into the form of a tape through a slot. In accordance with one aspect, the raw powder can include a material selected from the group consisting of a metal powder, a polymer compound, a ceramic material, and a mixture thereof, and each of the materials is combined with the organic compounds such as a cross-linking agent, a solvent, and/or a dispersing agent, etc., to maintain its shape. Then, the mixture P is applied to the surface of a carrier film 110 and is shaped into a thick film while passing through the slot defined between blades 112 and the carrier film 110. The film thickness can be adjusted by controlling a distance between the blades 112 and the carrier film 110.

The mixture P discharged in a non-dried state through the slot is called a green tape 120 and the thick film 63 is obtained by completely drying such a green tape 120.

The green tape 120 has plasticity in the non-dried state and can be processed to facilitate safekeeping, movement, etc., thereof. In addition, the green tape 120 is advantageous particularly in terms of consecutive processes and mass production.

The thick film 63 obtained by drying the green tape 120 is punched to form through-holes and disposed on another thick film 63 to produce the tape 62, as shown in FIG. 6 (a). According to one embodiment, the thick film 63 can be produced into the tape 62, in which the grooves 65a are directly formed through a molding operation, as shown in FIG. 6 (b). Furthermore, during the above processes, it is possible to further stack an upper or lower secondary thick film 64a or 64b on the upper or lower surface of the green tape 120 having the through-holes or the grooves 65a formed therein or to perform other processes such as cutting with respect to the green tape 120. In accordance with one aspect, the tape 62 can be molded or changed to a desired shape by such processes. As a result, the diamond tool can be manufactured in various desired shapes.

A method of manufacturing a diamond tool having a configuration as described above according to one embodiment is described as follows.

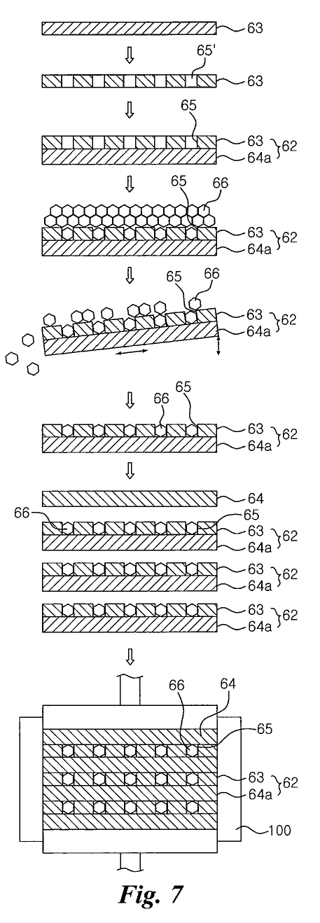

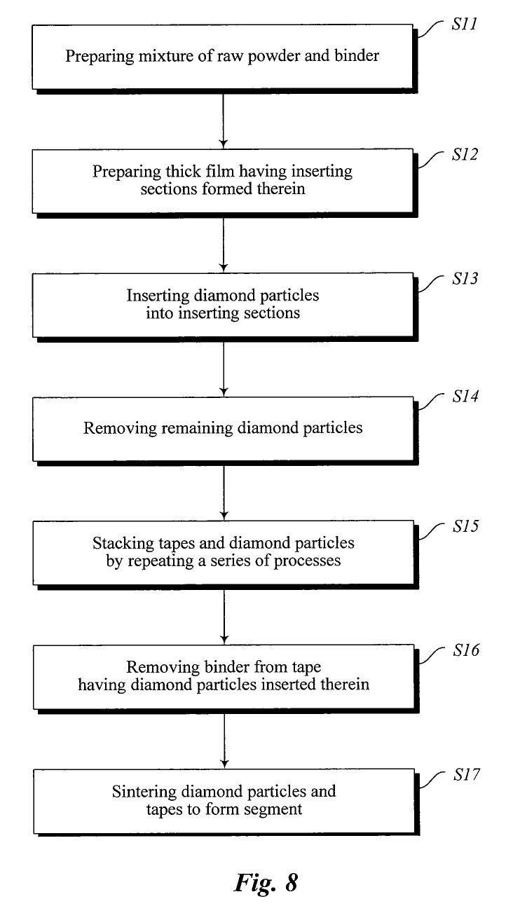

FIG. 7 is a flow diagram showing a segment at different steps of a method of manufacturing a diamond tool according to one embodiment, and FIG. 8 is a flow chart showing a method of manufacturing a diamond tool according to one embodiment.

Referring to FIGS. 7 and 8, the method of manufacturing the diamond tool 50 comprises preparing a tape 62 having a plurality of inserting sections 65 formed therein corresponding to desired arrangement locations of diamond particles 66.

In accordance with one aspect, preparing the tape 62 includes preparing a mixture of a raw powder and a binder (S11). According to one embodiment, the raw powder can be a metal powder bonded to the diamond particles 66 by sintering. The raw powder may be formed of a polymer compound or a ceramic material in place of the metal powder. In accordance with one aspect, the raw powder is formed of a material selected from the metal powder, the polymer compound, the ceramic material or a mixture thereof, and includes other materials for improvement in performance.

Then, the mixture of the raw powder and the binder is molded into a green tape 120 having a desired predetermined shape by a tape casting apparatus. Then, the green tape 120 is dried and forms a thick film 63, a portion of which is formed with a plurality of through-holes 65′ or grooves 65a to constitute inserting section 65 on the surface of the thick film 63 (S12). The thick film 63 is formed to the tape 62, which can be individually used or can be provided at the lower surface with a lower secondary thick film 64a, which does not have an inserting section, to provide a tape 62 having the through-holes closed at one side thereof. The inserting sections 65 may be formed on the tape 62 to correspond to arrangement locations of the diamond particles 65.

In accordance with one aspect, the tape 62 can be formed before supplying the diamond particles 66 or can be prepared in a completed state.

In accordance with one aspect, the inserting sections 65 may have a size of approximately 110˜150% of the diamond particles 66. Therefore, it is possible to easily insert the diamond particles 66 into the respective inserting sections 65 while preventing two or more diamond particles 66 from being inserted into a single inserting section 65.

After preparing the tape 62 as described above, the diamond particles 66 are inserted into the inserting sections 65 of the tape 62 (S13).

At the step of inserting the diamond particles 66 into the inserting sections 65, a number of diamond particles 66 are set on the surface of the tape 62. In accordance with one aspect, each of the diamond particles 66 is inserted into a single inserting section 65 and remaining diamond particles 66 are piled up on the tape 62. The remaining diamond particles 66 which are not inserted into the inserting sections 65 are removed (S14).

In accordance with one aspect, removing the remaining diamond particles 66 includes tilting the tape 62 or applying vibration to the tape 62 such that the remaining diamond particles 66, which are not inserted into the inserting sections 65, can drop down from the tape 62.

In accordance with one aspect, inserting the diamond particles 66 includes supplying a number of diamond particles 66 slightly more than a number of inserting sections 65, and vibration is applied to the tape 62 to allow the diamond particles 66 to be inserted into the respective inserting sections 65. When the amount of diamond particles 66 supplied is controlled as described above, it is possible to reduce time required for the process of removing the remaining diamond particles 66 and the process of recovering the removed diamond particles 66.

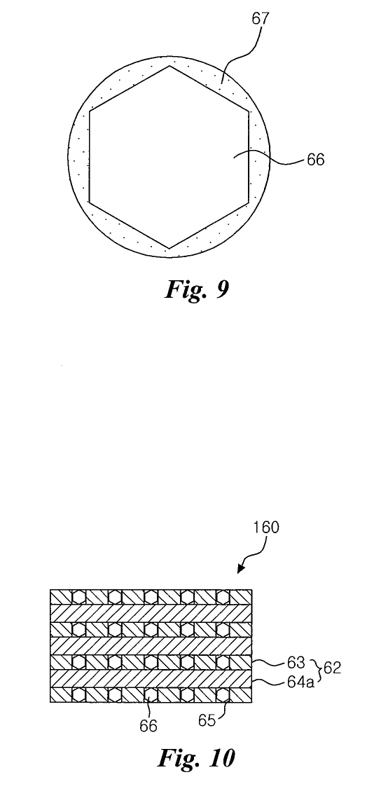

In accordance with one aspect, each of the diamond particles 66 may have a coating layer 67 on the surface thereof to facilitate supply and removal of the diamond particles, as shown in FIG. 9. FIG. 9 is a cross-sectional view illustrating a coated state of a diamond particle for the diamond tool according to one embodiment. The coating layer 67 is formed in a spherical shape on the surface of each of the diamond particles 67, so that the diamond particles 67 can move easily.

Referring to FIGS. 6 and 7 again, in the segment 60, the diamond particles 66 maybe arranged in a single layer or stacked in multiple layers. According to one embodiment, the method of manufacturing the diamond tool 50 includes forming multiple layers wherein additional tapes 62 having diamond particles 66 inserted in the other tapes 62 are stacked on the tape 62 having the diamond particles 66 therein.

Forming the multiples layers includes repeatedly preparing a plurality of the tapes 62, each of which has the plurality of inserting sections 65 formed therein corresponding to desired arrangement locations of the diamond particles 66, inserting the diamond particles 66 into the inserting sections 65 of each of the tapes 62, and stacking the tapes 62 one after another from below, such that the tapes 62 and the diamond particles 66 are stacked in multiple layers (S15).

Forming the multiple layers includes the tapes 62 providing in a completed state, with the inserting sections 65 formed in various arrangement patterns, for example, corresponding to previously programmed arrangement patterns of the diamond particles 66.

As such, since a number of tapes 62 can be previously produced to have the inserting sections 65 arranged in various patterns and indexed according to the patterns, it is possible to realize inventory control, which enables mass production and reduces manufacturing costs.

In addition, forming the multiple layers enables the tapes 62 and the diamond particles 66 to be more rapidly stacked in the multiple layers, thereby further increasing production speed.

In accordance with one aspect, an upper-secondary thick film 64b may be further stacked on the uppermost tape 62 and the diamond particles 66 thereof. In accordance with one aspect, the upper-secondary thick film 64b may have the same thickness as that of the lower-secondary thick film 64a on the lower surface of the lowermost tape 62. As a result, the tape 62 may be formed to have a symmetrical structure in the vertical direction and the respective secondary thick films 64a, 64b can be adjusted in thickness depending on characteristics of the diamond tool.

According to one embodiment, after the diamond particles 66 are inserted into the inserting sections 65 of each of the tapes 62, the binder is degreased from the tape 62 (S16). For example, when the binder is formed of an organic compound and creates impurities during pressure sintering, the method can further include degreasing the binder. At the degreasing step, the tapes 62 are heated to a temperature sufficient to vaporize the binder or more to remove the binder from the tapes 62.

After removing the binder, the tapes 62 having the diamond particles 66 inserted therein are subjected to pressure sintering (S17). The stacked tapes 62 and the diamond particles 66 are sintered to form the segment 60, which will be coupled to a shank 52, in a compression frame 100.

Then, one or more segments 60 formed by sintering are coupled to the outer periphery of the shank 52, thereby completing the diamond tool 50.

Although the segment formed by the method of forming the diamond tool 50 has been described as including the multiple layers of the tapes 62 and the diamond particles 66 in the above embodiment, the present invention is not limited to this and the segment may comprise a single layer of the tape 62 and the diamond particles 66.

Furthermore, according to one embodiment, the segment can be manufactured only by a thick film that has a plurality of through-holes formed therein, or can be manufactured by alternately stacking a number of such thick films in multiple layers.

FIG. 10 is a cross-sectional view illustrating a segment manufactured by a method of manufacturing a diamond tool according to another embodiment of the present invention.

Referring to FIG. 10, among tapes 62 of the segment according to this embodiment, the lower-secondary thick film 64b may not be disposed on the lower surface of the lowermost tape 62. Therefore, the tapes 62 have the lowermost layer which is formed of a thick film having through-holes to constitute the inserting sections 65.

For the tapes 62 of this embodiment, diamond particles 66 in the inserting sections 65 of the lowermost layer are exposed to the outside, and thus, when operating with a diamond tool 50, it becomes unnecessary to perform a process of exposing the diamond particles. Then, the tapes 62 having blocked lower surfaces may be additionally stacked in multiple layers on the lowermost tape 62, which is penetrated by the inserting sections 62. With the diamond particles 66 of the uppermost tape 62 exposed to the outside, the tapes 62 and the diamond particles 66 are sintered in a compression frame 100, forming a segment 160.

As apparent from the above description, in a diamond tool and a method of manufacturing the same according to embodiments of the present invention, inserting sections can be formed corresponding to arrangement locations of diamond particles in a thick film formed by a tape casting method so as to provide various arrangement patterns of diamond particles, so that the diamond tool has improved cutting efficiency. As such, with the improved cutting efficiency of the diamond tool, it is possible to reduce loss of energy by vibration and heat during cutting operation, and to enhance operating efficiency, degree of accuracy and service life of the diamond tool. Furthermore, when forming the tapes, the inserting sections can be formed in a constant size such that a single diamond particle can be inserted into a single inserting section. Furthermore, a method of manufacturing a diamond tool according to embodiments of the present disclosure allows automation of the processes and cost savings while increasing the yield. Furthermore, since the thick films for the tapes can be maintained in a semi-dried state, safekeeping and movement of the thick films can be easily attained and a diamond tool having a desired shape can be manufactured using such thick films.

Although the present invention has been described with reference to the embodiments and the accompanying drawings, it is not limited to the embodiments and the drawings. It should be understood that various modifications and changes can be made to the present invention by those skilled in the art without departing from the spirit and scope of the present invention defined by the accompanying claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A diamond tool comprising,
a shank;
a segment coupled to the shank and including a tape having a plurality of inserting sections formed on a surface of the tape; and
a plurality of diamond particles inserted into the inserting sections and bonded to the tape, the plurality of inserting sections being formed on the surface of the tape corresponding to desired arrangement locations of the diamond particles.

2. The diamond tool according to claim 1 wherein the tape includes a thick film having a plurality of through-holes formed on a surface of the thick film to form the inserting sections.

3. The diamond tool according to claim 2 wherein the tape includes a secondary thick film disposed on a lower surface of the thick film to block the through-holes.

4. The diamond tool according to claim 1 wherein the tape includes a thick film having a plurality of grooves formed on a surface of the thick film to form the insertion sections.

5. The diamond tool according to claim 1 wherein the segment includes a secondary thick film stacked on an upper surface of the tape having the diamond particles inserted into the tape.

6. The diamond tool according to claim 1 wherein the segment includes a plurality of tapes stacked in multiple layers, each of the tapes having diamond particles inserted therein.

7. The diamond tool according to claim 1 wherein the inserting sections have a size of 110˜150% of a size of the diamond particles, respectively.

8. The diamond tool according to claim 1 wherein the tape includes a material selected from the group consisting of a metal powder, a polymer compound, a ceramic material, and a mixture thereof.

9. A method of manufacturing a diamond tool, comprising:
forming a plurality of inserting sections in a tape corresponding to desired arrangement locations of diamond particles;
inserting the diamond particles into the inserting sections of the tape; and
bonding the diamond particles to the inserting sections of the tape to form a segment.

10. The method according to claim 9 wherein forming the plurality of inserting sections includes:
preparing a mixture of a raw powder and a binder
forming a thick film from the mixture; and
forming a plurality of through-holes in the thick film corresponding to the desired arrangement locations of the diamond particles.

11. The method according to claim 10 wherein the through-holes are formed in the thick film after drying the thick film formed by of the mixture.

12. The method according to claim 10 wherein the mixture is applied to a lower surface of the thick film to form a secondary thick film to block the through-holes.

13. The method according to claim 9 wherein forming the plurality of inserting sections includes:
preparing a mixture of a raw powder and a binder
forming a thick film from the mixture; and
forming a plurality of grooves in the thick film corresponding to the arrangement locations of the diamond particles.

14. The method according to claim 9 wherein inserting the diamond particles includes supplying the diamond particles onto the surface of the tape, and removing remaining diamond particles that are not inserted into the inserting sections.

15. The method according to claim 14 wherein removing the remaining diamond particles includes tilting the tape or applying vibration to the tape to remove the remaining diamond particles that are not inserted into the inserting sections.

16. The method according to claim 9, further comprising:
stacking a secondary thick film on an upper surface of the tape having the diamond particles inserted therein, the bonding of the diamond particles to the tape including pressure sintering the diamond particles and the tape.

17. The method according to claim 9, further comprising:
forming a plurality of inserting sections in at least one additional tape corresponding to desired arrangement locations of diamond particles, inserting the diamond particles into the inserting sections of at least one tape; and
stacking the tapes having diamond particles inserted therein to form multiple layers, the bonding of the diamond particles to the tape including pressure sintering the tapes and the diamond particles,

18. The method according to claim 9 wherein bonding the diamond particles includes degreasing a binder and pressure sintering the diamond particles and the tape.

19. The method according to claim 9 wherein the raw powder includes a material selected from the group consisting of a metal powder, a polymer compound, a ceramic material, and a mixture thereof.

20. The method according to claim 9 wherein the inserting sections have a size of 110˜150% of a size of the diamond particles.

21. The method according to claim 9, further comprising:
forming a spherical coating layer on the surface of each of the diamond particles before inserting the diamond particles.

22. The diamond tool of claim 1 wherein the diamond particles are bonded to the tape by a pressure sintering process.
